(19) United States
(12) Patent Application Publication
(10) Pub. No.: US 2009/0127835 A1
(43) Pub. Date: May 21, 2009

(54) WEARABLE AIRBAG SYSTEM AND METHOD

(76) Inventor: HSIU-PING LIN, Taipei (TW)

Correspondence Address: HSIU-PING LIN, 3F., No.18-6, Jinhua St., Taipei, omitted

(21) Appl. No.: 12/263,121

(22) Filed: Oct. 31, 2008

(30) Foreign Application Priority Data
Oct. 31, 2007 (TW) 96141102

(51) Int. Cl. B60R 21/16

(52) U.S. Cl. 280/730.1

(57) ABSTRACT

The present invention is related to a wearable airbag system applied for protecting a human on a vehicle. The wearable airbag system may include a wearable airbag module and a measurement module. The wearable airbag module may include an airbag configured to expand the volume of the airbag if the airbag is inflated and an inflator configured to be coupled with the airbag and generate a gas to inflate the airbag. The measurement module may be configured to measure a condition of the vehicle and control the inflator to inflate the airbag if the condition achieves or exceeds a limitation.

### CROSS-REFERENCE TO RELATED APPLICATIONS

This application claims the benefit of Taiwanese Patent Application No. 96141102, filed Oct. 31, 2007.

### BACKGROUND OF THE INVENTION

The present invention relates to airbag systems. More particularly, the present invention relates to wearable airbag systems configured to detect conditions of vehicles to determine if wearable airbags should be inflated or not.

Conventionally, airbags are applied in a car for protecting a driver or a passenger inside the car when an car accident happens. Airbag applied on a motorcycle can also be found in the prior art such as U.S. Pat. No. 6,848,709 B2, those disclosed in the prior art applying airbag to prevent another vehicle or object impact a rider directly in an accident. However, to those general kinds of motorcycle accidents, except the impact at the front or a side of the motorcycle, another kind of accident may cause the motorcycle to be turned over or toppled and may lie on a side of the motorcycle. The rider of the motorcycle may therefore be separated from the motorcycle and thus hits the ground or other object around him/her. The airbag disposed on the motorcycle may not be capable of providing enough protection to the rider of the motorcycle.

Examples of the prior art techniques about wearable airbags applied on motorcycle may be found or disclosed in U.S. Pat. No. 4,059,852, U.S. Pat. No. 4,089,065, U.S. Pat. No. 4,825,469, U.S. Pat. No. 4,984,821, U.S. Pat. No. 6,125,478 and U.S. Patent Application Publication numbered 2006/0123206 A1. Those prior art disclosed a separable connector member such as a rope attached a motorcycle at one side and attached to a airbag jacket worn by a rider at the other side. When a motorcycle accident happens, the rider may be separated from the motorcycle, and thus connection of the separable connector member may not be remained. In the prior art, the force that separate the connector member from the motorcycle or from the airbag jacket may be measured by a sensor, and airbags disposed inside the airbag jacket will be inflated to protect the rider if the force is stronger than a predetermined limitation. However, those invention in the prior art may not be applicable in some cases. Moreover, if the rider forget to turn off the sensor before taking off the motorcycle, then the airbags inside the airbag jacket may also be inflated due to the rider's leaving the motorcycle. Furthermore, in other kinds of motorcycle accident, the rider may not be separated from the motorcycle, but may be moved in the same direction or with the moving of the motorcycle after the motorcycle is hit or turned down. In these kinds of situation, it may be hard to decide if it is the occasion to inflate the airbag inside the airbag jacket or not, since the connector member may not be separated.

Moreover, when trying to apply the airbag jacket of the prior art to passengers inside a car, a train, a bus, a boat or an airplane (e.g. the bus may suddenly be braked down and cause passengers inside the bus falling down or hitting objects inside the chamber of the bus), it may not be suitable to apply the connector member in these kind of vehicles. Also, it may not be convenient to the passengers inside the kinds of vehicles, since they may move inside the vehicle.

Furthermore, examples of applications about wearable airbags can also be found in those prior art such as U.S. Pat. No. 5,500,952, U.S. Pat. No. 7,017,195, U.S. Pat. No. 7,150,048 and US. Patent Application Publication numbered 2005/0067816 A1. These kinds of prior art technologies disclosed or described wearable airbag clothes, either a top or a pants, coupled with a sensor to sense the movement of a person wearing the wearable airbag clothes. When the person falls down, the sensor will sense the situation and inflate an airbag of the wearable airbag clothes to protect the person. However, these kinds of sensing method may not be useful in the situation that the person is taking a vehicle and an accident happens to the vehicle, since the sensor is not directly sense the situation of the vehicle, but only the situation of the person wear the wearable airbag clothes. Moreover, the person may move in the vehicle, and the movement of the person may cause the sensor of the wearable airbag clothes to become malfunction.

### BRIEF SUMMARY OF THE INVENTION

Examples of the present invention may provide a wearable airbag system applied for protecting a human on a vehicle. The wearable airbag system may include a wearable airbag module and a measurement module. The wearable airbag module may include an airbag configured to expand the volume of the airbag if the airbag is inflated and an inflator configured to be coupled with the airbag and generate a gas to inflate the airbag. The measurement module may be configured to measure a condition of the vehicle and control the inflator to inflate the airbag if the condition achieves or exceeds a limitation.

Some examples of the present invention may provide a method for protecting a human on a vehicle with wearable airbag. The method may include measuring a condition of the vehicle, deciding if the condition achieves or exceeds a limitation or not, and inflating an airbag of a wearable airbag module if the condition achieves or exceeds a limitation.

Other examples of the present invention may also provide a method for protecting a human on a vehicle with wearable airbag. The method may include deciding if the vehicle is moving at a speed over a speed limitation or not, deciding if a transmitter disposed on the vehicle works regularly to be capable of transmitting a link signal or not, deciding if a receiver coupled with a wearable airbag module works regularly to be capable of receiving the link signal or not, wherein the wearable airbag module comprises an airbag and an inflator coupled with the airbag and capable of inflating the airbag, deciding if the intensity of the link signal received by the receiver coupled with the wearable airbag module is smaller than or equal to an signal intensity limitation or not, and

controlling the inflator of the wearable airbag module to inflate the airbag of the wearable airbag module if the vehicle is moving at a speed over the speed limitation, the transmitter works regularly to be capable of transmitting the link signal, the receiver works regularly to be capable of receiving the link signal, and the intensity of the link signal is smaller than or equal to an signal intensity limitation.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

In the drawings:

FIG. 1 is a diagram illustrating a wearable airbag system according to one embodiment of the present invention;

FIG. 2 is a diagram illustrating a wearable airbag system according to another embodiment of the present invention;

FIGS. 3A and 3B are diagrams illustrating the operating condition of the wearable airbag system illustrated in FIG. 2;

FIG. 4 is a diagram illustrating the measurement module of the wearable airbag system illustrated in FIG. 2;

FIG. 5 is a diagram illustrating a wearable airbag system according to yet another embodiment of the present invention;

FIG. 6 is a diagram illustrating a wearable airbag system according to still other embodiment of the present invention;

FIG. 7 is a diagram illustrating a wearable airbag system according to yet other embodiment of the present invention;

FIG. 8 is a diagram illustrating a wearable airbag system according to one embodiment of the present invention;

FIG. 9 is a diagram illustrating a wearable airbag system according to one embodiment of the present invention;

FIG. 10 is a diagram illustrating a wearable airbag system according to other embodiment of the present invention;

FIG. 11 is a flowchart illustrating a method for protecting a human on a vehicle with wearable airbag according to one embodiment of the present invention;

FIG. 12 is a flowchart illustrating a method for protecting a human on a vehicle with wearable airbag according to another embodiment of the present invention;

FIG. 13 is a flowchart illustrating a method for protecting a human on a vehicle with wearable airbag according to still another embodiment of the present invention;

FIG. 14 is a flowchart illustrating a method for protecting a human on a vehicle with wearable airbag according to yet another embodiment of the present invention;

FIG. 15 is a flowchart illustrating a method for protecting a human on a vehicle with wearable airbag according to other embodiment of the present invention;

FIG. 16 is a flowchart illustrating a method for protecting a human on a vehicle with wearable airbag according to still other embodiment of the present invention;

FIG. 17 is a flowchart illustrating a method for protecting a human on a vehicle with wearable airbag according to yet other embodiment of the present invention;

FIG. 18 is a flowchart illustrating a method for protecting a human on a vehicle with wearable airbag according to another embodiment of the present invention;

FIGS. 19A and 19B are diagrams illustrating operating condition of a wearable airbag system according to one embodiment of the present invention;

FIGS. 20A and 20B are diagrams illustrating operating condition of a wearable airbag system according to another embodiment of the present invention;

FIGS. 21A and 21B are diagrams illustrating operating condition of a wearable airbag system according to still another embodiment of the present invention;

FIGS. 22A and 22B are diagrams illustrating a wearable airbag module according to an embodiment of the present invention;

FIGS. 23A and 23B are diagrams illustrating a wearable airbag module according to another embodiment of the present invention;

FIGS. 24A and 24B are diagrams illustrating wearable airbag modules according to other embodiment of the present invention;

FIGS. 25A and 25B are diagrams illustrating a wearable airbag module according to still another embodiment of the present invention;

FIGS. 26A and 26B are diagrams illustrating a wearable airbag module according to yet another embodiment of the present invention; and

FIGS. 27A and 27B are diagrams illustrating an integrated wearable airbag module according to other embodiment of the present invention.

### DETAILED DESCRIPTION OF THE INVENTION

Reference will now be made in detail to the present examples of the invention, examples of which are illustrated in the accompanying drawings. Wherever possible, the same reference numbers will be used throughout the drawings to refer to the same or like parts.

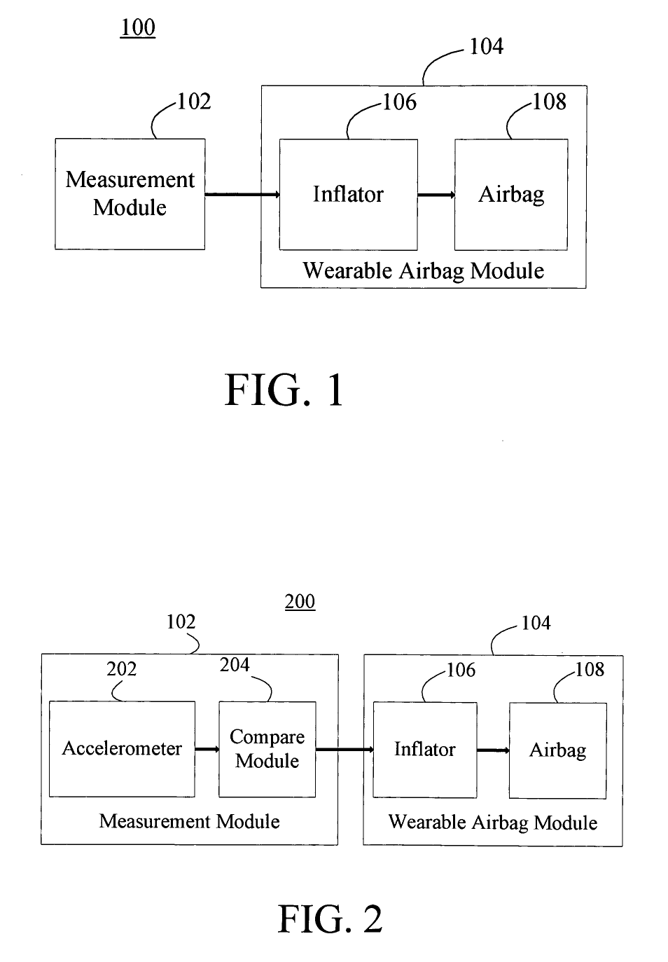

FIG. 1 is a diagram illustrating a wearable airbag system 100 according to one embodiment of the present invention. Referring to FIG. 1, the wearable airbag system 100 may be applicable to protect a human who uses the wearable airbag system 100 and puts on a wearable airbag module 104 when driving or taking a vehicle in or prior to an accident of the vehicle. The wearable airbag system 100 may include a measurement module 102 and the wearable airbag module 104. The wearable airbag module 104 may include an airbag 108 configured to expand the volume of the airbag if the airbag is inflated and an inflator 106 configured to be coupled with the airbag 108 and generate a gas to inflate the airbag 108. The measurement module 102 may be configured to measure a condition of the vehicle, and control the inflator 106 to inflate the airbag 108 if the condition achieves or exceeds a limitation.

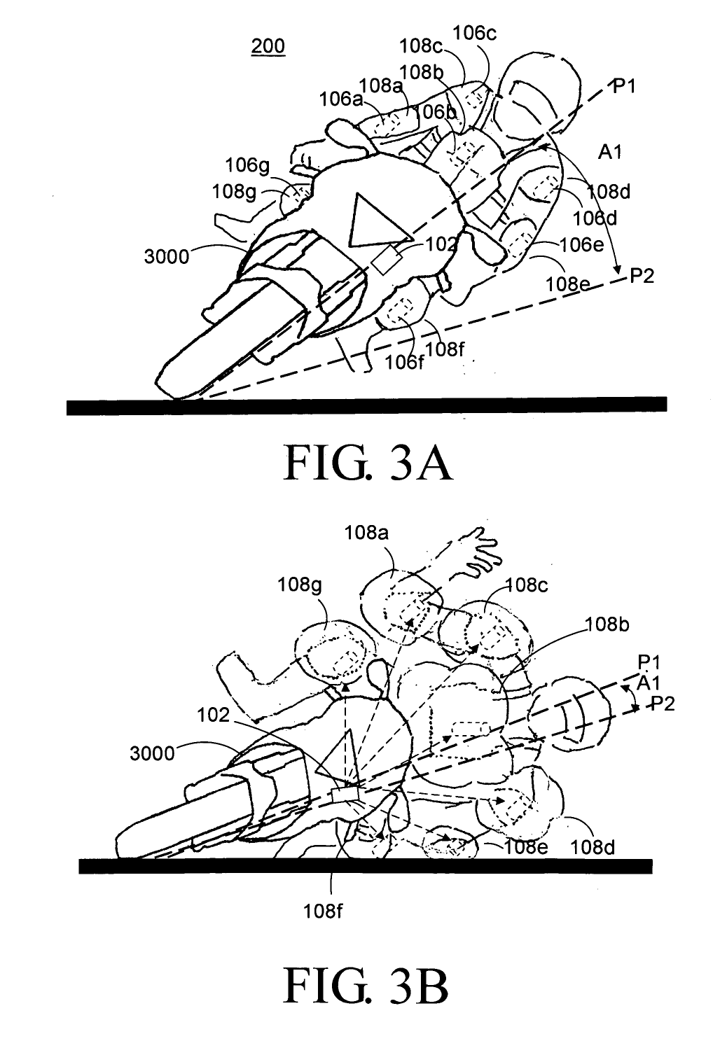

In one embodiment, the measurement module 102 may include a tilt measurement module configured to measure a tilt condition of the vehicle. In this embodiment, the condition of the vehicle is the tilt condition of the vehicle and the limitation is a tilt limitation of the vehicle. Moreover, the measurement module 102 may control the inflator 106 to inflate the airbag 108 if the tilt condition of the vehicle achieves or exceeds the tilt limitation of the vehicle to protect the human wearing the wearable airbag module. More details of the embodiment will further be described or illustrated with reference to FIG. 2, FIGS. 3A and 3B, FIG. 4, FIGS. 5A and 5B, FIG. 6 and FIG. 7.

FIG. 2 is a diagram illustrating a wearable airbag system 200 according to another embodiment of the present invention. Referring to FIG. 2, the wearable airbag system 200 may be same or similar to the wearable airbag system 100 described or illustrated with reference to FIG. 1, except that the measurement module 102 may include an accelerometer 202 and a compare module 204. The accelerometer 202 may be configured to measure the tilt condition of the vehicle by measuring the value and the direction of the acceleration of the vehicle. Detail embodiment of applying accelerometers (e.g. 2-axis, 3-axis or multi-axis accelerometer) to measure tilt conditions may be found in the prior art relating to applications of accelerometers or motion ICs, for example, the dual-axis accelerometer of Analog Device, Inc. such as ADXL320EB. Moreover, the compare module 204 may be configured to compare the tilt condition of the vehicle with the tilt limitation of the vehicle. The inflator 106 will inflate the airbag 108 if the tilt condition of the vehicle achieves or exceeds the tilt limitation of the vehicle.

FIGS. 3A and 3B are diagrams illustrating the operating condition of the wearable airbag system 200 illustrated in FIG. 2. Referring to FIG. 3A, the wearable airbag system 200 may include the measurement module 102 and a plurality of wearable airbag modules, wherein the plurality of wearable airbag modules can be worn on different parts of a human body. The plurality of wearable airbag modules may include inflators 106a, 106b, 106c, 106d, 106e, 106f and 106g, and airbags 108a, 108b, 108c, 108d, 108e, 108f and 108g. The accelerometer 202 may be configured to measure the change of an included angle A1 between a first tangent plane P1 of a motorcycle 3000 and a reference target such as a second reference plane P2 according to the tilt condition of the motorcycle 3000. The compare module 204 may be configured to compare the included angle A1 with a predetermined angle (not shown in the figure).

Referring to FIG. 3B, when the included angle A1 is smaller than the predetermined angle, that is, the tilt condition of the motorcycle 3000 achieves or exceeds the tilt limitation to make the included angle A1 smaller than the predetermined angle, the compare module 204 may generate a inflation signal (as those dashed arrows shown in FIG. 3B) to the inflators 106a, 106b, 106c, 106d, 106e, 106f and 106g, and the inflators 106a, 106b, 106c, 106d, 106e, 106f and 106g may then inflates the airbags 108a, 108b, 108c, 108d, 108e, 108f and 108g, accordingly, to protect the human. Those skilled in the art can easily understand that the included angle A1 or the tangent plane P1 may be any imaginary tangent plane of the motorcycle 3000. In another example, the included angle A1 can be replaced by an exterior angle or angular displacement. In other example, the tangent plane P1 can be replaced by any other imaginary cross-section plane of the motorcycle 3000. Those planes are only used to described the way the accelerometer 202 measures the tilt condition of the vehicle (i.e. the motorcycle 3000 in this embodiment), and thus should not be the limitation of the claimed range of the present invention.

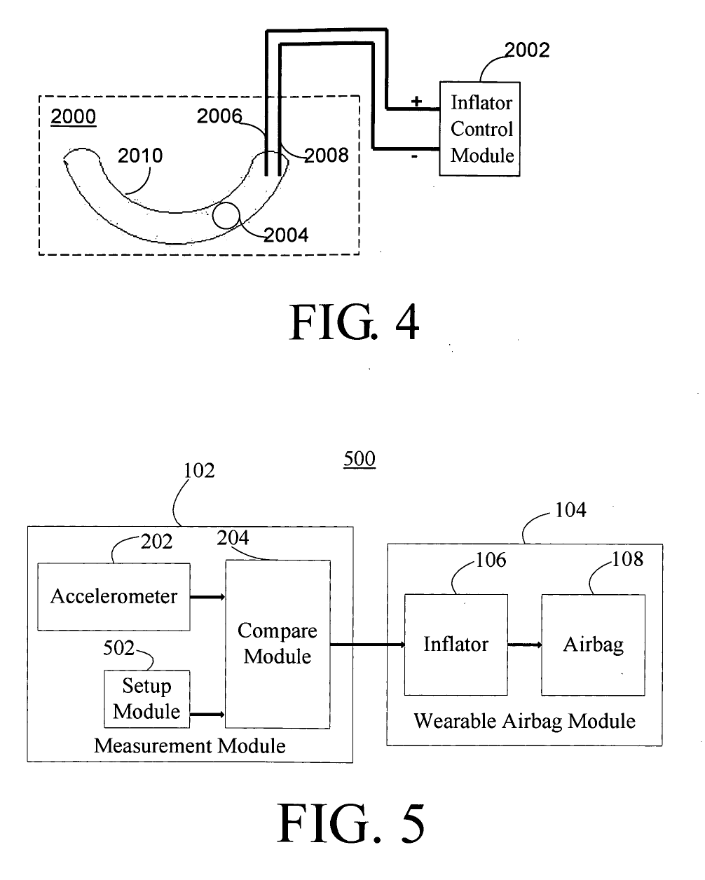

FIG. 4 is a diagram illustrating the measurement module 102 of the wearable airbag system 200 illustrated in FIG. 2 according to still another embodiment of the present invention. Referring to FIG. 4, the measurement module 102 may include a mercury switch 2000 and an inflator control module 2002. The mercury switch 2000 may include a mercury ball 2004, a first electrode 2006, a second electrode 2008 and a tube 2010, wherein the mercury ball 2004 is capable of moving inside the tube 2010 accordingly to the tilt condition of the vehicle. The mercury switch 2000 may be configured to be turned “on”, that is, the mercury ball 2004 touches the first electrode 2006 and/or the second electrode, if the tilt condition of the vehicle does not achieve or exceed the tilt limitation of the vehicle and turned “off” if the tilt condition of the vehicle achieves or exceeds the tilt limitation of the vehicle. The inflator control module 2002 may be configured to be coupled with the mercury switch 2000 and control the inflator 106 to inflate the airbag if the mercury switch is turned off Those skilled in the art can easily understand that the use of the mercury switch in embodiments of the present invention should not be limited to the way like the mercury switch 2000. In one example, the mercury switch can be configured to be turned “off” if the tilt condition of the vehicle does not achieve or exceed the tilt limitation of the vehicle and turned “on” if the tilt condition of the vehicle achieves or exceeds the tilt limitation of the vehicle.

FIG. 5 is a diagram illustrating a wearable airbag system 500 according to yet another embodiment of the present invention. Referring to FIG. 5, the wearable airbag system 500 may be same or similar to the wearable airbag system 200 described or illustrated with reference to FIG. 2, except that the measurement module 102 may further include a setup module 502 configured to set up or change the tilt limitation of the vehicle. Moreover, the change of the tilt limitation of the vehicle may take advantage of being suitable for different user driving or taking the vehicle.

Referring to FIG. 5 again, in one embodiment, the accelerometer 202 may be configured to measure variation of a speed of the vehicle. Accordingly, the compare module 204 may be configured to compare the variation of the speed of the vehicle with a speed variation limitation of the vehicle, and control the inflator 106 to inflate the airbag 108 if the variation of the speed of the vehicle achieves or exceeds the speed variation limitation of the vehicle. Moreover, the setup module 502 may be configured to set up the speed variation limitation of the vehicle. Therefore, the measurement module 102 may be capable of measuring rapid deceleration of the vehicle due to suddenly brake down the vehicle and control the wearable airbag module 104 to protecting the human wearing it. Those skilled in the art can easily understand that the variation of the speed of the vehicle may comprise suddenly accelerate the vehicle or decelerate the vehicle, and both conditions may cause danger to the human or user driving or taking the vehicle, and thus the accelerometer 202 may be configured to measure both conditions to prevent the damage to the human wearing the wearable airbag module 104.

FIG. 10 is a diagram illustrating a wearable airbag system 1000 according to other embodiment of the present invention. Referring to FIG. 10, the wearable airbag system 1000 may be same or similar to the wearable airbag system 500 described or illustrated with reference to FIG. 5, except that the accelerometer 202 is replaced by an impact measurement module 702. The impact measurement module 702 may be disposed on the vehicle and configured to measure the value of impact force acting on the vehicle and pass the intensity of the impact force to the compare module 204. The compare module 204 may be configured to compare the intensity of the impact force with a intensity limitation value, and control the inflator 106 to inflate the airbag 108 if the intensity of the impact force achieves or exceeds a intensity limitation value.

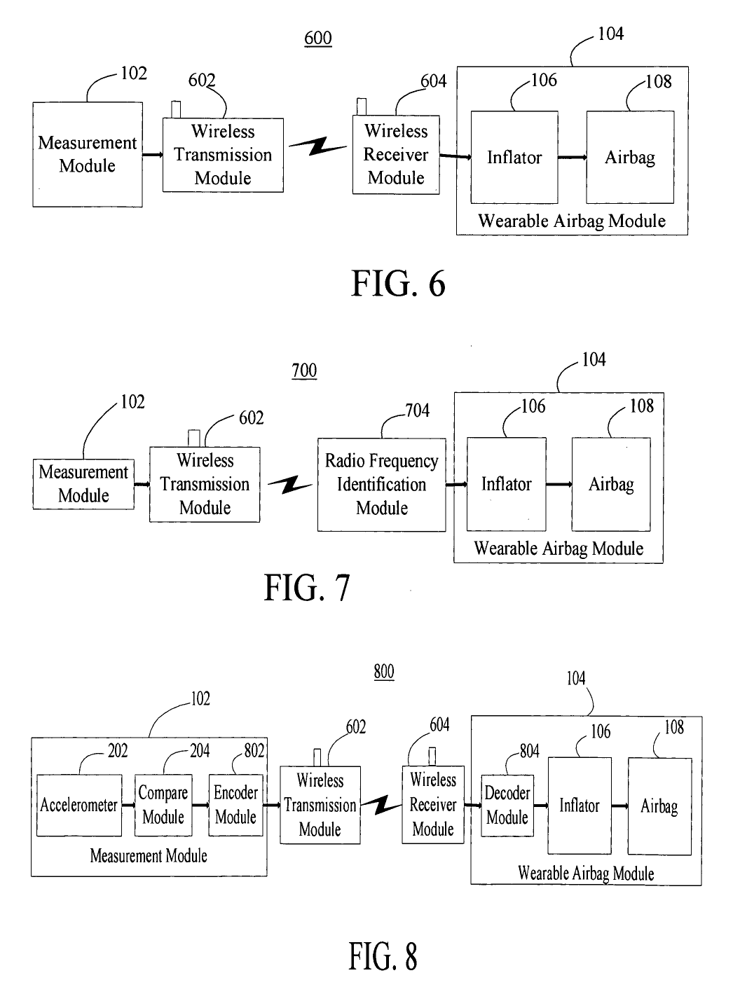

FIG. 6 is a diagram illustrating a wearable airbag system 600 according to still other embodiment of the present invention. Referring to FIG. 6, the wearable airbag system 600 may be same or similar to the wearable airbag system 100 described or illustrated with reference to FIG. 1, except that the wearable airbag system 600 may further include a wireless transmission module 602 and a wireless receiver module 604. The wireless transmission module 602 may be coupled with the measurement module 102 and configured to transmit the inflation signal if the condition of the vehicle achieves or exceeds the limitation of the vehicle. The wireless receiver module 604 may be coupled with the inflator 106 and configured to receive the inflation signal, wherein the inflator 106 inflates the airbag 108 if the wireless receiver module 604 receives the inflation signal.

FIG. 7 is a diagram illustrating a wearable airbag system 700 according to yet other embodiment of the present invention. Referring to FIG. 7, the wearable airbag system 700 may be same or similar to the wearable airbag system 600 described or illustrated with reference to FIG. 6, except that the wireless receiver module of the wearable airbag system 600 may be replaced by a radio frequency identification (RFID) module 704. The RFID module 704 may be configured to control the inflator 106 to inflate the airbag 108 if the RFID module 704 identifies an inflation signal transmitted by the wireless transmission module.

FIG. 8 is a diagram illustrating a wearable airbag system 800 according to one embodiment of the present invention. Referring to FIG. 8, the wearable airbag system 800 may be same or similar to the wearable airbag system 600 described or illustrated with reference to FIG. 6, except that the wearable airbag system 800 may further include an encoder module 802 and a decoder module 804. The encoder module 802 may be configured to encode the inflation signal, and the decoder module 804 may be configured to decode the encoded inflation signal. Those skilled in the art can easily understand that the way the encoder module 802 encode the inflation signal could be any encoding method, for example, a convolutional encoding method, and the decoder module 804 may decode the inflation signal accordingly to the encoding method.

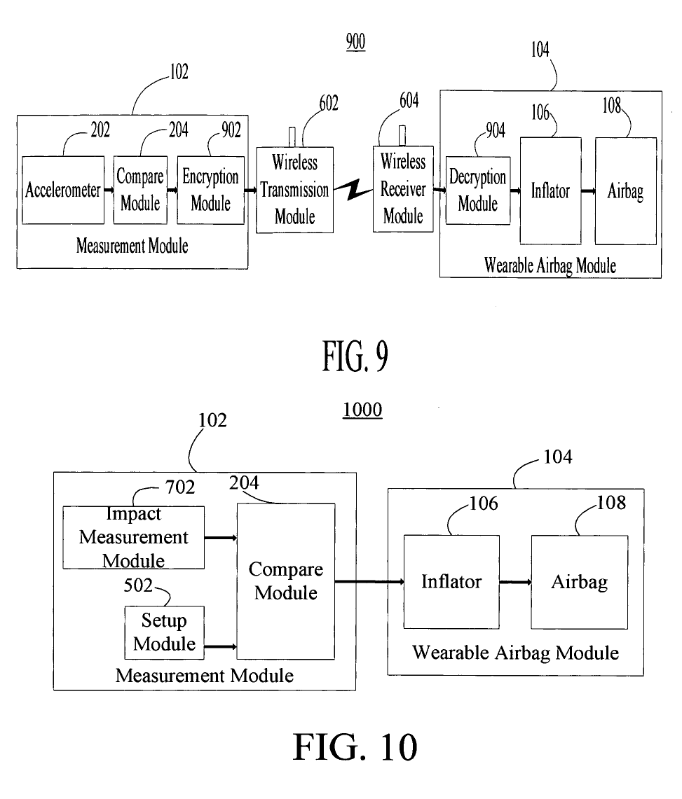

FIG. 9 is a diagram illustrating a wearable airbag system 900 according to one embodiment of the present invention. Referring to FIG. 9, the wearable airbag system 900 may be same or similar to the wearable airbag system 600 described or illustrated with reference to FIG. 6, except that the wearable airbag system 900 may further include an encryption module 902 and a decryption module 904. The encryption module 902 may be configured to encrypt the inflation signal, and the decryption module 904 may be configured to decode the encoded inflation signal. Those skilled in the art can easily understand that the encryption of the inflation signal may take advantage of preventing other inflation signal generated from other measurement module to make the wearable airbag module 104 become malfunction, if the measurement module 102 and the wearable airbag module 104 applies the same public key or private key.

In one embodiment, the wearable airbag system as those disclosed in FIG. 6 to FIG. 9 may further include a first sensor module (not shown in the figures) configured to sense if the wireless transmission module is wirelessly coupled with the wireless receiver module.

In another embodiment, the wearable airbag system as those disclosed in FIG. 6 to FIG. 9 may further include a second sensor module (not shown in the figures) configured to sense if the vehicle is moving at a speed over a speed limitation or not. If the vehicle is moving at the speed over the speed limitation, the inflator 106 is capable of being controlled to inflate the airbag when the condition of the vehicle achieves or exceeds the limitation, and if the first switch is turned off, the airbag 108 is never inflated no matter the condition of the vehicle achieves or exceeds the limitation or not.

In another embodiment, the wearable airbag system as those disclosed in FIG. 1 to FIG. 9 may further include a first switch, wherein if the first switch is turned on, the inflator 106 is capable of being controlled to inflate the airbag 108 when the condition of the vehicle achieves or exceeds the limitation, and if the first switch is turned off, the airbag is never inflated no matter the condition of the vehicle achieves or exceeds the limitation or not.

In still another embodiment, the wearable airbag system as those disclosed in FIG. 1 to FIG. 9 may further include a second switch configured to make the inflator inflates the airbag directly if the second switch is turned on, no matter what condition of the vehicle. The second switch may be applicable by a user who sense a emergent situation that an accident is going to be happened and make the user be able to control the airbag 108 to protect himself/herself directly.

In yet another embodiment, the vehicle may comprise at least a bicycle, a motorcycle, a car, a train, a boat or an airplane.

In other embodiment, the wearable airbag module 104 may be configured to be worn in clothes or out of the clothes of a user.

In still other embodiment, the measurement module 102 may be configured to be attached on the vehicle and thus move according to the vehicle, for example, if an old man is taking a vehicle such as a bus, a train or an airplane, he/she can wear the wearable airbag module 104 and attach the measurement module 102 on the vehicle (e.g. the measurement module 102 may include a magneto capable of being attached on some iron part of the vehicle). Then, the measurement module 102 will move as the vehicle moves, and thus will measure or detect danger situation and control the wearable airbag module 104 to protect the old man when necessary.

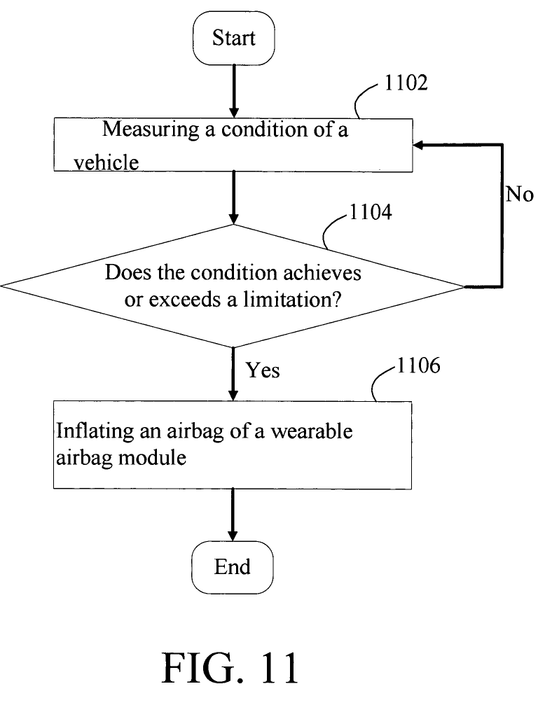

FIG. 11 is a flowchart illustrating a method for protecting a human on a vehicle with wearable airbag according to one embodiment of the present invention. Referring to FIG. 11, at step 1102, a measurement module such as the abovementioned measurement module 102 described and illustrated with reference to those abovementioned figures may measure a condition of a vehicle. At step 1104, the measurement module may decide if the condition achieves or exceeds a limitation or not. If the condition does achieve or exceed a limitation, then at step 1106, an inflator (e.g. the inflator 106) may inflate an airbag (e.g. the airbag 108) of a wearable airbag module (e.g. the wearable airbag module 104) if the condition achieves or exceeds a limitation. Otherwise if the condition does not achieve or exceed the limitation, then go back to step 1102.

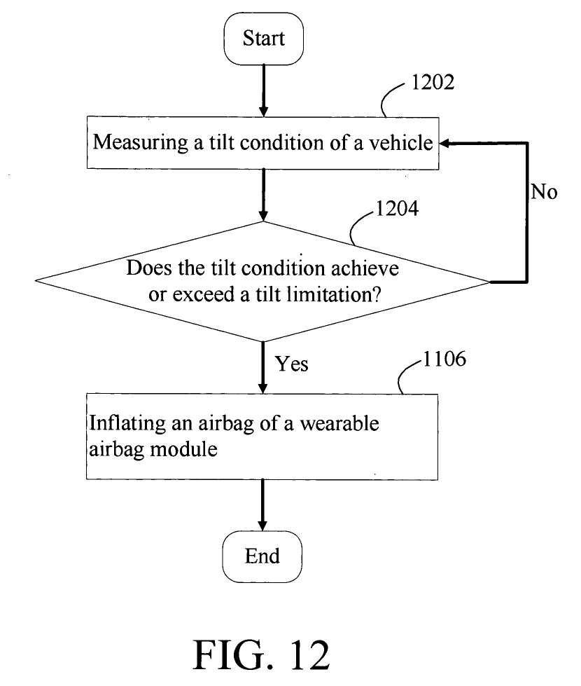

FIG. 12 is a flowchart illustrating a method for protecting a human on a vehicle with wearable airbag according to another embodiment of the present invention. Referring to FIG. 12, the method may be same or similar as those described and illustrated with reference to FIG. 11, except that at step 1202, the measurement module may measure a tilt condition of the vehicle, and at step 1204, the measurement module may decide if the tilt condition achieves or exceeds a tilt limitation of the vehicle or not.

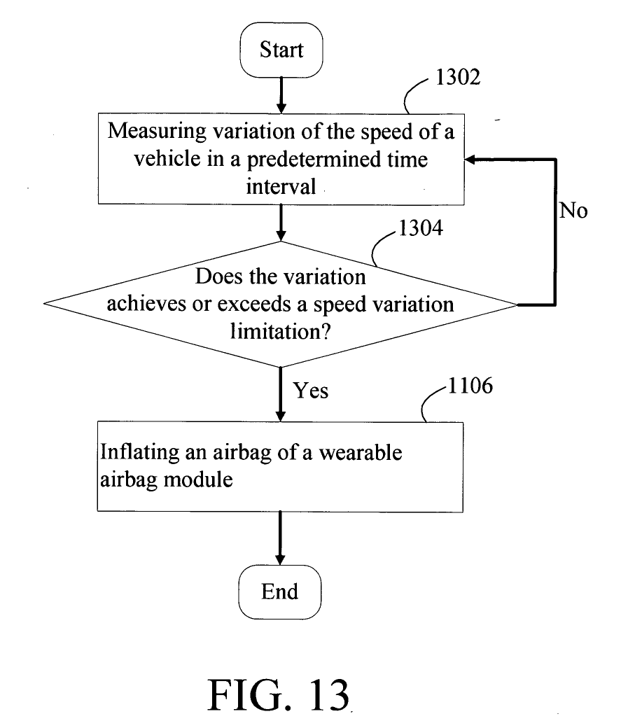

FIG. 13 is a flowchart illustrating a method for protecting a human on a vehicle with wearable airbag according to still another embodiment of the present invention. Referring to FIG. 13, the method may be same or similar as those described and illustrated with reference to FIG. 11, except that at step 1302, the measurement module may measure variation of the speed of the vehicle in a predetermined time interval, and at step 1304, the measurement module may decide if the variation of the speed of the vehicle measured in the predetermined time interval achieves or exceeds a speed variation limitation or not.

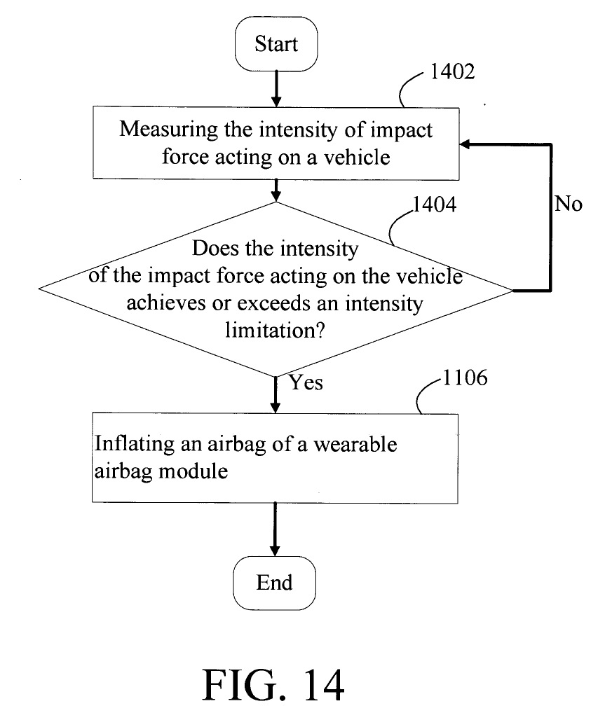

FIG. 14 is a flowchart illustrating a method for protecting a human on a vehicle with wearable airbag according to yet another embodiment of the present invention. Referring to FIG. 14, the method may be same or similar as those described and illustrated with reference to FIG. 11, except that at step 1402, the measurement module may measure the intensity of impact force acting on the vehicle, and at step 1404, the measurement module may decide if the impact force acting on the vehicle achieves or exceeds a intensity limitation or not.

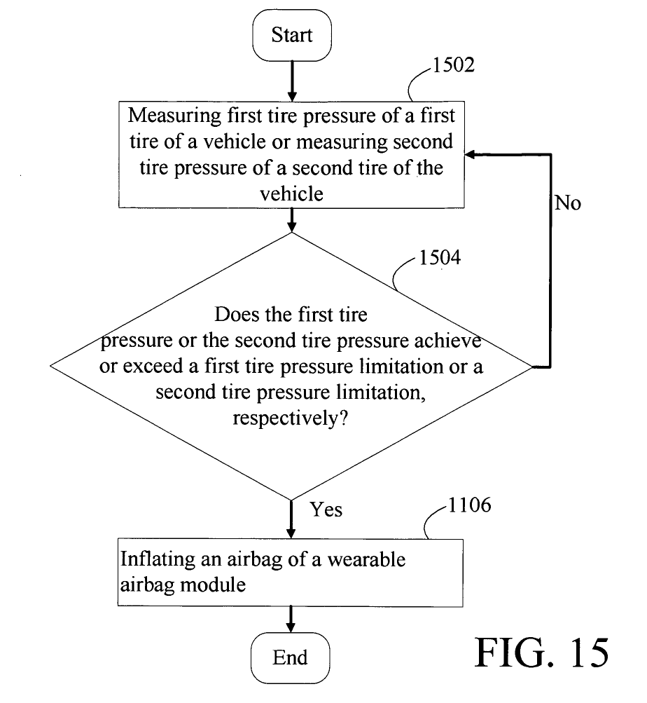

FIG. 15 is a flowchart illustrating a method for protecting a human on a vehicle with wearable airbag according to other embodiment of the present invention. Referring to FIG. 15, at step 1502, a measurement module such as the abovementioned measurement module 102 described and illustrated with reference to those abovementioned figures may measure first tire pressure of a first tire of a vehicle or second tire pressure of a second tire of the vehicle. At step 1504, the measurement module may decide if the first tire pressure and/or the second tire pressure achieves or exceeds a first tire pressure limitation and/or a second tire pressure limitation or not. If yes, then at step 1106, an inflator (e.g. the inflator 106) may inflate an airbag (e.g. the airbag 108) of a wearable airbag module (e.g. the wearable airbag module 104) if the condition achieves or exceeds a limitation.

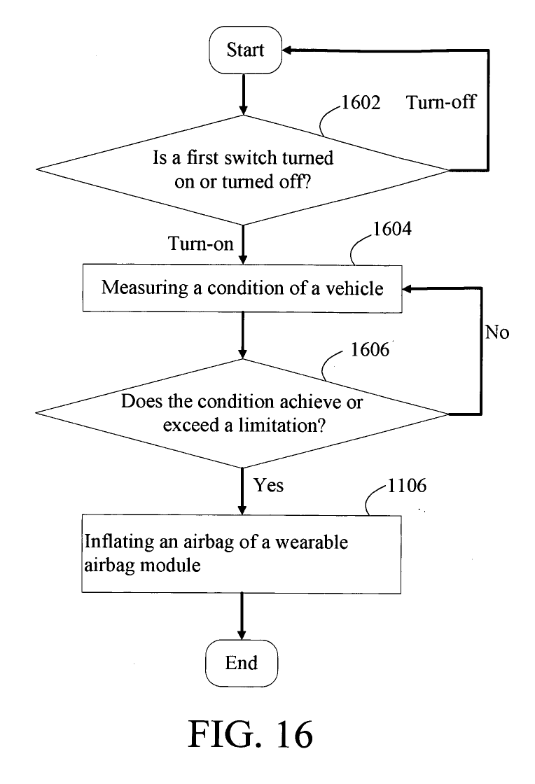

FIG. 16 is a flowchart illustrating a method for protecting a human on a vehicle with wearable airbag according to still other embodiment of the present invention. Referring to FIG. 16, at step 1602, a wearable airbag system such as those described or illustrated with reference to FIG. 1 may decide if a first switch is turned on or turned off. If the first switch is turned on, then go to step 1604. Otherwise if the first switch is turned off, then go back to step 1602. At step 1604, a measurement module of the wearable airbag system may measure a condition of a vehicle. Next, at step 1606, the measurement module may decide if the condition achieves or exceeds a limitation. Finally, at step 1106, an inflator (e.g. the inflator 106) may inflate an airbag (e.g. the airbag 108) of a wearable airbag module (e.g. the wearable airbag module 104) if the condition achieves or exceeds the limitation.

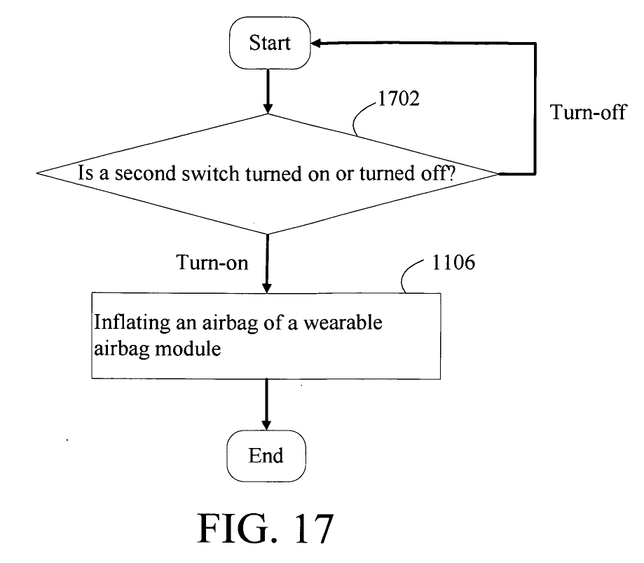

FIG. 17 is a flowchart illustrating a method for protecting a human on a vehicle with wearable airbag according to yet other embodiment of the present invention. Referring to FIG. 17, at step 1702, a wearable airbag system such as those described or illustrated with reference to FIG. 1 may decide if a second switch is turned on or turned off. If the second switch is turned on, then go to step 1106. Otherwise if the second switch is turned off, then restart the flow. Then, at step 1106, an inflator (e.g. the inflator 106) may inflate an airbag (e.g. the airbag 108) of a wearable airbag module (e.g. the wearable airbag module 104) if the condition achieves or exceeds the limitation.

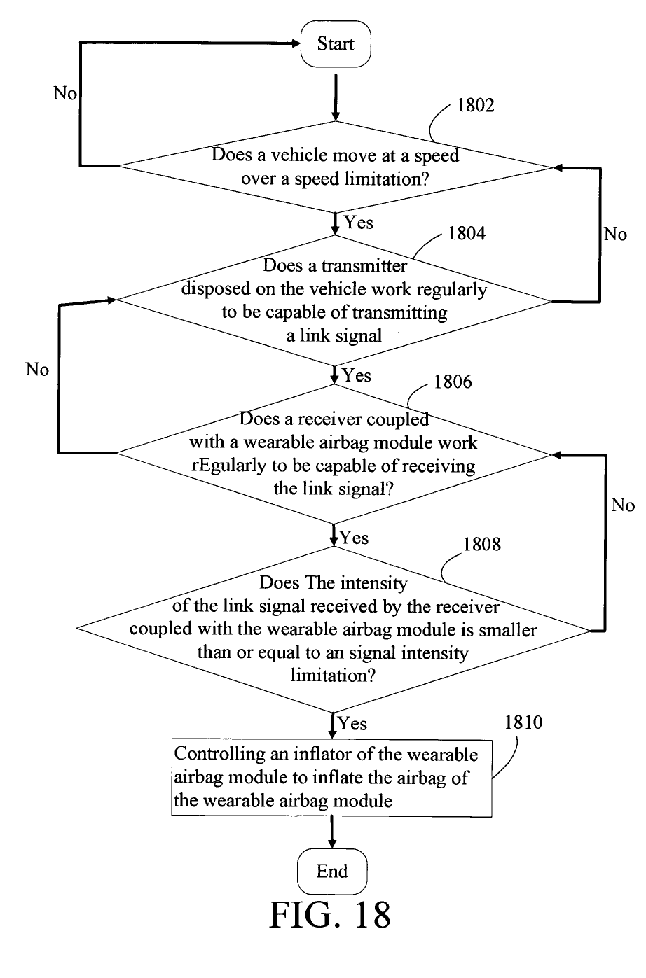

FIG. 18 is a flowchart illustrating a method for protecting a human on a vehicle with wearable airbag according to another embodiment of the present invention. Referring to FIG. 18, at step 1802, a wearable airbag system such as those described or illustrated with reference to FIG. 1 may decide if a vehicle moves at a speed over a speed limitation or not. If yes, then go to step 1804. If no, restart the flow. Next, the wearable airbag system may decide if a transmitter disposed on the vehicle works regularly to be capable of transmitting a link signal or not. If yes, then go to step 1806. If no, go back to step 1802. Next, a receiver coupled with a wearable airbag module works regularly to be capable of receiving the link signal or not. If yes, then go to step 1808. If no, go back to step 1804. Then, the wearable airbag system may decide if the intensity of the link signal received by the receiver coupled with the wearable airbag module is smaller than or equal to an signal intensity limitation or not. If yes, then go to step 1810. If no, go back to step 1806. Finally, at step 1810, the wearable airbag system may control an inflator of the wearable airbag module to inflate an airbag of the wearable airbag module if the vehicle is moving at a speed over an signal intensity limitation.

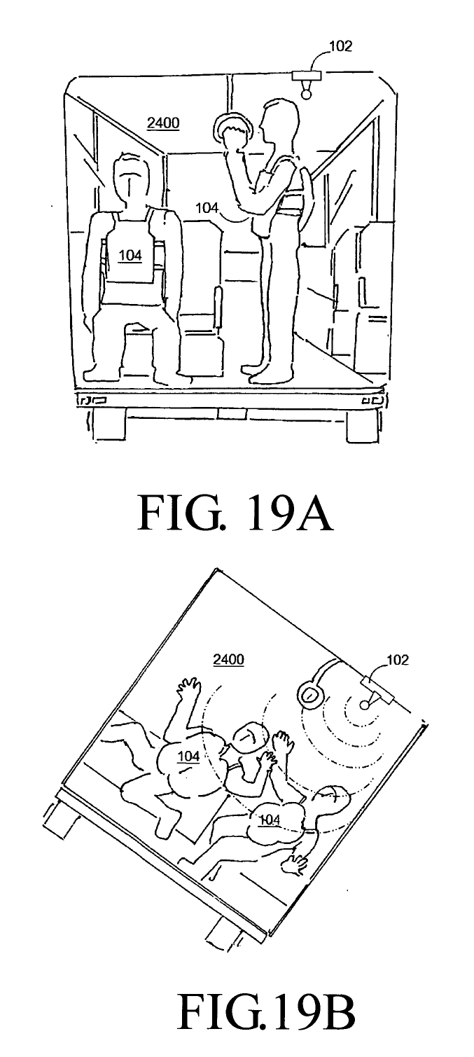

FIGS. 19A and 19B are diagrams illustrating operating condition of a wearable airbag system 2400 according to one embodiment of the present invention. Referring to FIG. 19A, the wearable airbag system 2400 may be applied to a chamber of a bus (or a train). In this embodiment, a passenger may wear a wearable airbag module 104, and a measurement module 102 may be disposed in the chamber. Referring to FIG. 19B, if for some reason the bus (or train) is going to topple or fall down, the measurement module 102 will measure a tilt condition of the bus (or train), and control the wearable airbag module 104 worn by the passenger to inflate its airbag to protect the passenger. In another example, the bus (or train) may be impacted in a car accident, and the measurement module 102 may measure the impact force or deceleration of the bus (or train) and decide if it is necessary to inflate the airbag to protect the passenger.

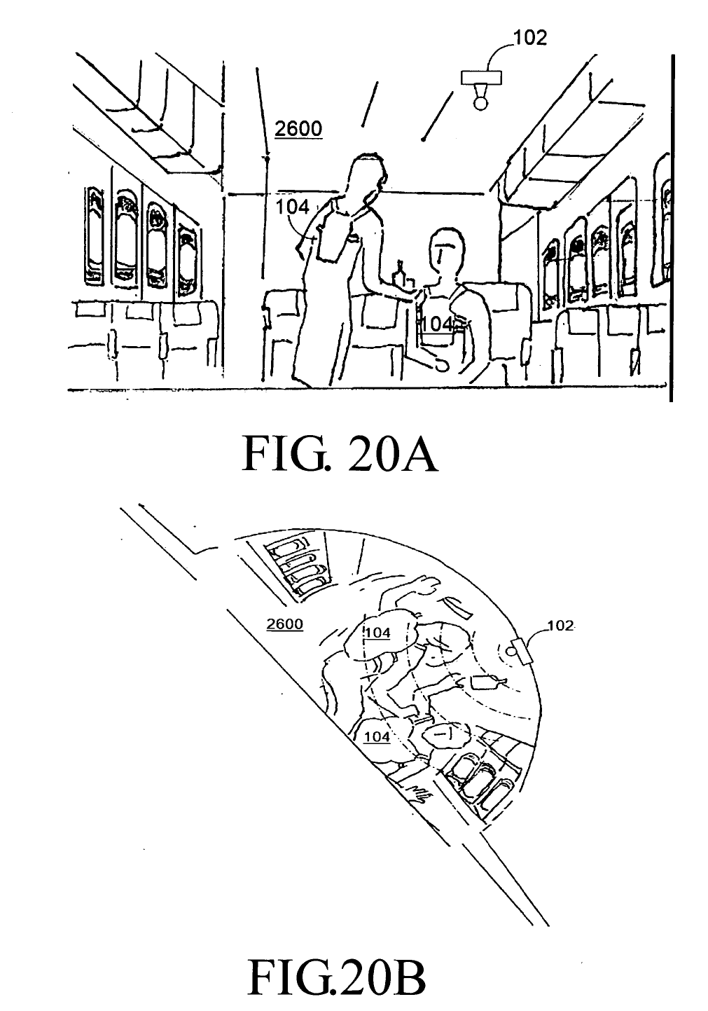

FIGS. 20A and 20B are diagrams illustrating operating condition of a wearable airbag system 2600 according to another embodiment of the present invention. Referring to FIG. 20A, the wearable airbag system 2600 may be applied to a chamber of an airplane. In this embodiment, a passenger may wear a wearable airbag module 104, and a measurement module 102 may be disposed inside the chamber of the airplane. Referring to FIG. 20B, if for some reason the airplane is flipped, the measurement module 102 will measure a tilt condition of the airplane, and control the wearable airbag module 104 worn by the passenger to inflate its airbag to protect the passenger and eliminate or prevent the damage.

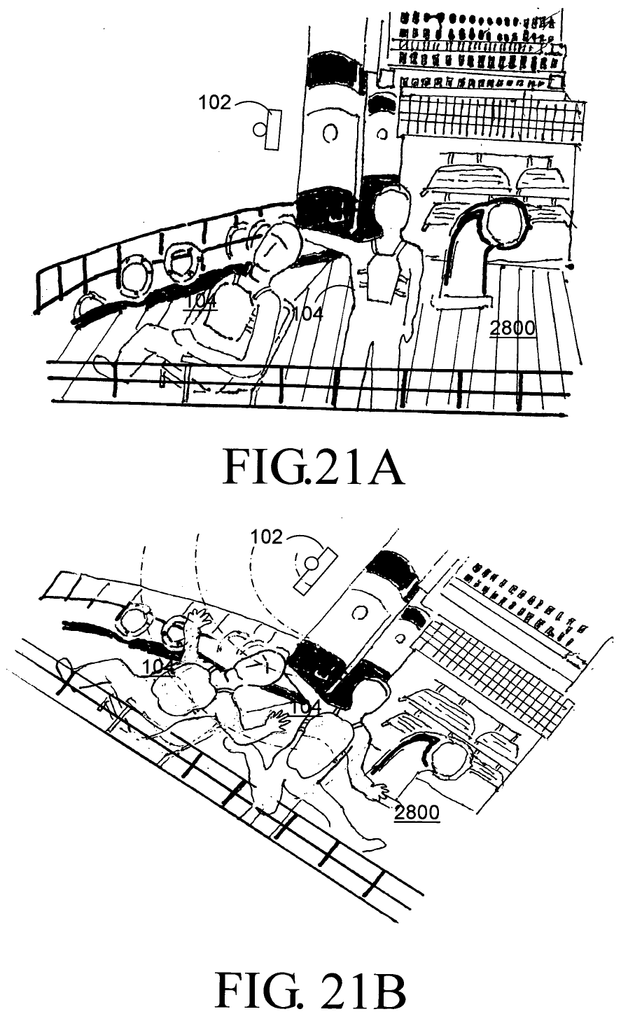

FIGS. 21A and 21B are diagrams illustrating operating condition of a wearable airbag system 2800 according to still another embodiment of the present invention. Referring to FIG. 21A, the wearable airbag system 2800 may be applied to a deck of a boat (or ship). In this embodiment, a passenger may wear a wearable airbag module 104, and a measurement module 102 may be disposed somewhere on the deck. Referring to FIG. 21B, if for some reason the boat is flipped or going to topple, the measurement module 102 will measure a tilt condition of the airplane, and control the wearable airbag module 104 worn by the passenger to inflate its airbag to protect the passenger and eliminate or prevent the damage. Those skilled in the art can also understand that the inflated airbag 108 may be capable of generate a floating power, and thus if the passenger falls into the water, the wearable airbag module 104 may also be applicable to become a life buoy.

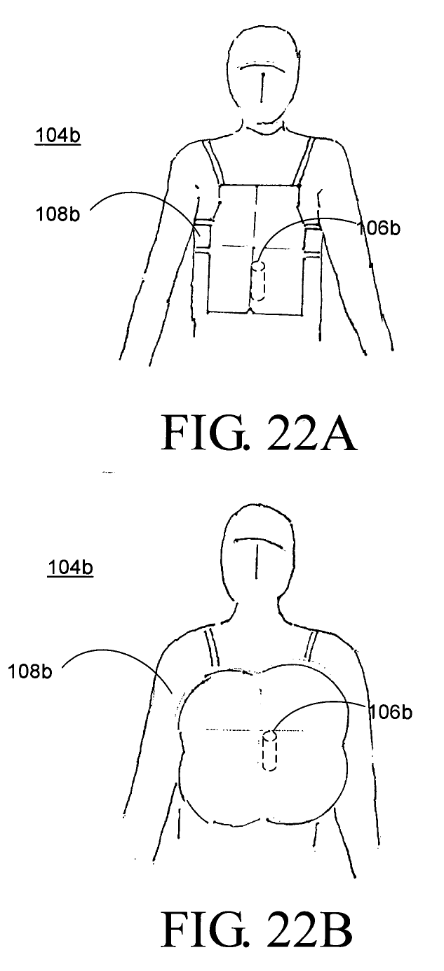

FIGS. 22A and 22B are diagrams illustrating a wearable airbag module 104b according to an embodiment of the present invention. Referring to FIG. 22A, the wearable airbag module 104b may be configured to protect the chest or front trunk (or body) of a user wearing the wearable airbag module 104b to cover his/her chest or front trunk. Referring to FIG. 22B, once an accident is measured by a measurement module 102, an inflator 106b of the wearable airbag module 104b will inflate an airbag 108b of the wearable airbag module 104b to protect the chest or front trunk of the user.

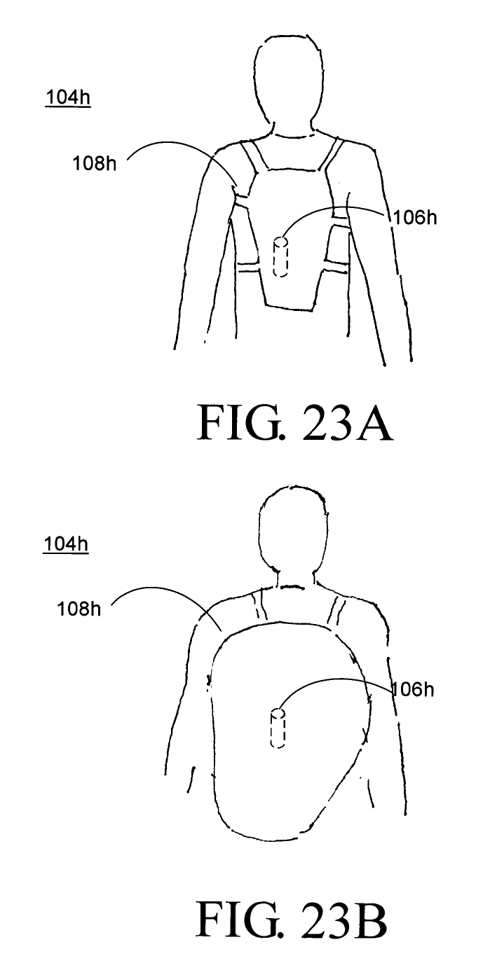

FIGS. 23A and 23B are diagrams illustrating a wearable airbag module 104h according to another embodiment of the present invention. Referring to FIG. 23A, the wearable airbag module 104h may be configured to protect the back trunk (or back) of a user wearing the wearable airbag module 104h to cover his/her back. Referring to FIG. 23B, once an accident is measured by a measurement module 102, an inflator 106h of the wearable airbag module 104h will inflate an airbag 108h of the wearable airbag module 104h to protect the back of the user.

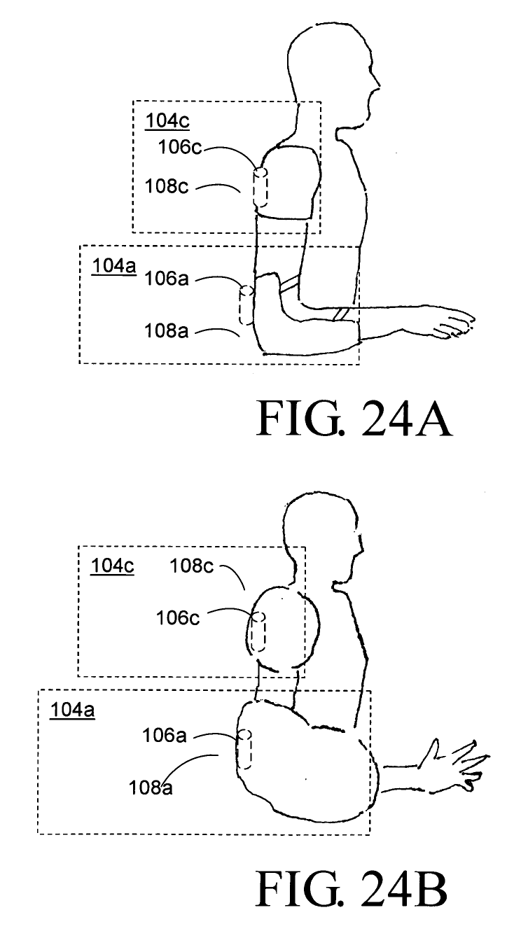

FIGS. 24A and 24B are diagrams illustrating wearable airbag modules 104a and 104c according to other embodiment of the present invention. Referring to FIG. 24A, the wearable airbag module 104a may be configured to protect an elbow of a user wearing the wearable airbag module 104a to cover his/her elbow, and the wearable airbag module 104c may be configured to protect a shoulder of a user wearing the wearable airbag module 104c to cover his/her shoulder. Referring to FIG. 24B, once an accident is measured by a measurement module 102, the wearable airbag module 104a and 104h will inflate their airbags 108a and 108c by their inflators 106a and 106c to protect the elbow and/or the shoulder of the user, respectively.

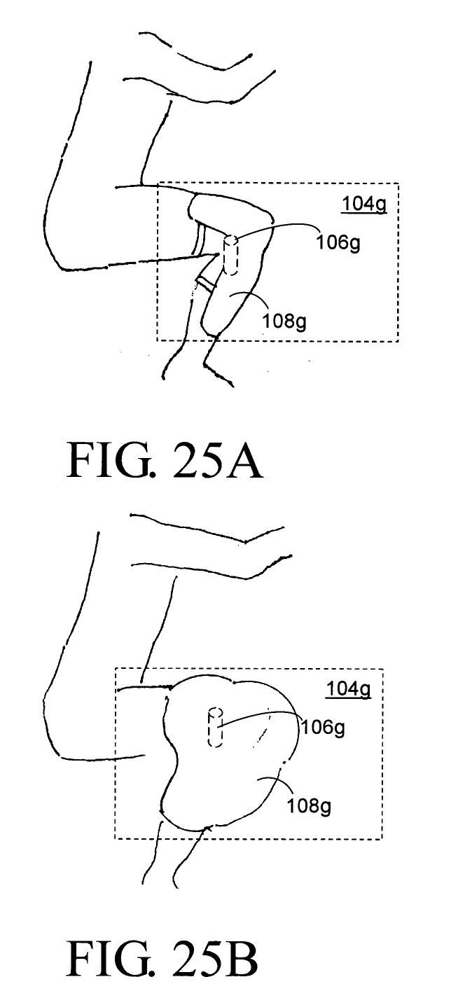

FIGS. 25A and 25B are diagrams illustrating a wearable airbag module 104g according to still another embodiment of the present invention. Referring to FIG. 25A, the wearable airbag module 104g may be configured to protect a knee of a user wearing the wearable airbag module 104g to cover his/her knee. Referring to FIG. 25B, once an accident is measured by a measurement module 102, an inflator 106g of the wearable airbag module 104g will inflate an airbag 108g to protect the knee of the user.

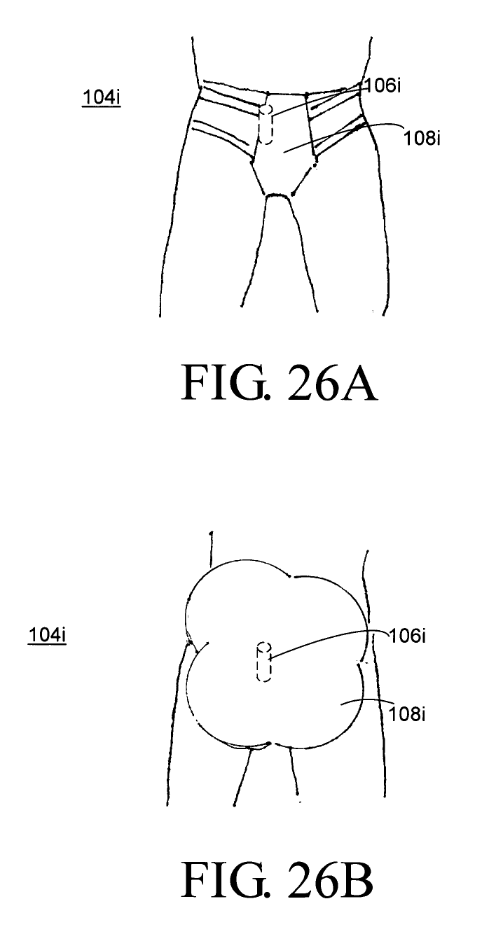

FIGS. 26A and 26B are diagrams illustrating a wearable airbag module 104i according to yet another embodiment of the present invention. Referring to FIG. 26A, the wearable airbag module 104i may be configured to protect the genitals of a user wearing the wearable airbag module 104g to cover his/her genitals. Referring to FIG. 26B, once an accident is measured by a measurement module 102, an inflator 106i of the wearable airbag module 104i will inflate an airbag 108i to protect the genitals of the user.

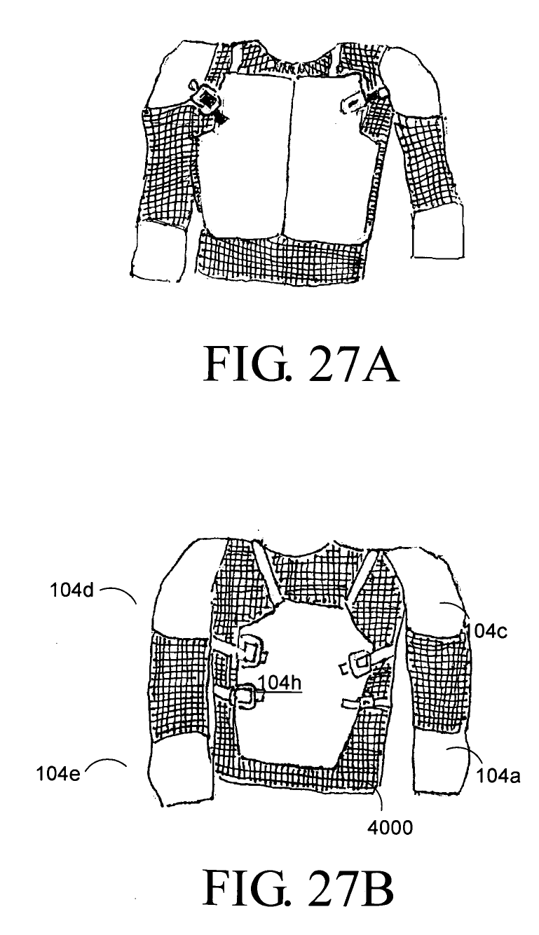

FIGS. 27A and 27B are diagrams illustrating an integrated wearable airbag module 104 according to other embodiment of the present invention, wherein the front view of the integrated wearable airbag module 104 is illustrated in FIG. 27A and the back view of the integrated wearable airbag module 104 is illustrated in FIG. 27B. Those skilled in the art can easily understand that at least one of the sub-modules (i.e. the wearable airbag module 104a to 104h described or illustrated with reference to the abovementioned figures) may be integrated together to form a clothes comprising airbags.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

Further, in describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. A wearable airbag system applied for protecting a human on a vehicle, comprising:
a wearable airbag module comprising:
an airbag configured to expand the volume of the airbag if the airbag is inflated; and
an inflator configured to be coupled with the airbag and generate a gas to inflate the airbag; and
a measurement module configured to measure a condition of the vehicle, and control the inflator to inflate the airbag if the condition achieves or exceeds a limitation.

2. The wearable airbag system of claim 1, wherein the measurement module comprises:
a tilt measurement module configured to measure a tilt condition of the vehicle as the condition,
wherein the limitation is a tilt limitation of the vehicle and the inflator inflates the airbag if the tilt condition of the vehicle achieves or exceeds the tilt limitation of the vehicle.

3. The wearable airbag system of claim 2, wherein the tilt measurement module comprises:
an accelerometer configured to measure the tilt condition of the vehicle; and
a compare module configured to compare the tilt condition of the vehicle with the tilt limitation of the vehicle,
wherein the inflator inflates the airbag if the tilt condition of the vehicle achieves or exceeds the tilt limitation of the vehicle.

4. The wearable airbag system of claim 2, wherein the tilt measurement module comprises:
a mercury switch configured to be turned off if the tilt condition of the vehicle does not achieve or exceed the tilt limitation of the vehicle and turned on if the tilt condition of the vehicle achieves or exceeds the tilt limitation of the vehicle; and
a control module configured to be coupled with the mercury switch and control the inflator to inflate the airbag if the mercury switch is turned on.

5. The wearable airbag system of claim 2, wherein the tilt measurement module comprises:
a mercury switch configured to be turned on if the tilt condition of the vehicle does not achieve or exceed the tilt limitation of the vehicle and turned off if the tilt condition of the vehicle achieves or exceeds the tilt limitation of the vehicle; and
an inflator control module configured to be coupled with the mercury switch and control the inflator to inflate the airbag if the mercury switch is turned off.

6. The wearable airbag system of claim 2, wherein the vehicle comprises a first tire and a second tire, the tilt measurement module comprising:
a tire pressure measurement module configured to measure a first tire pressure of the first tire and the second tire pressure of the second tire, and control the inflator to inflate the airbag if the value of the first tire pressure and/or the second tire pressure varies from a range because that the tilt condition of the vehicle achieves or exceeds the tilt limitation of the vehicle.

7. The wearable airbag system of claim 1, wherein the measurement module comprises:
an impact measurement module disposed on the vehicle, the impact measurement module being configured to measure the value of impact force acting on the vehicle; and
a compare module configured to compare the intensity of the impact force with a intensity limitation value, and control the inflator to inflate the airbag if the intensity of the impact force achieves or exceeds a intensity limitation value.

8. The wearable airbag system of claim 1, wherein the measurement module comprises:
an accelerometer configured to measure variation of a speed of the vehicle in a predetermined time interval; and
a compare module configured to compare the variation of the speed of the vehicle in the predetermined time interval with a speed variation limitation of the vehicle, and control the inflator to inflate the airbag if the variation of the speed of the vehicle achieves or exceeds the speed variation limitation of the vehicle.

9. The wearable airbag system of claim 1, further comprising:
a setup module configured to setup or change the limitation.

10. The wearable airbag system of claim 1, wherein the measurement module generate a inflation signal, the wearable airbag system further comprising:
a wireless transmission module, coupled with the measurement module, configured to transmit the inflation signal if the condition of the vehicle achieves or exceeds the limitation of the vehicle; and
a wireless receiver module, coupled with the inflator, configured to receive the inflation signal,
wherein the inflator inflates the airbag if the wireless receiver module receives the inflation signal.

11. The wearable airbag system of claim 10, wherein the wireless transmission module comprises at least one of a radio frequency transmitter configured to transmit the inflation signal at radio frequency, an RFID transmitter configured to transmit the inflation signal through radio frequency identification or other electromagnetic wave transmitter capable of transmitting the inflation signal through electromagnetic wave.

12. The wearable airbag system of claim 10, further comprising:
a encoder module configured to encode the inflation signal; and
a decoder module configured to decode the encoded inflation signal.

13. The wearable airbag system of claim 10, further comprising:
a encryption module configured to encrypt the inflation signal; and
a decryption module configured to decrypt the encrypted inflation signal.

14. The wearable airbag system of claim 10, further comprising:
a first sensor module configured to sense if the wireless transmission module is wirelessly coupled with the wireless receiver module.

15. The wearable airbag system of claim 1, further comprising:
a second sensor module configured to sense if the vehicle is moving at a speed over a speed limitation or not,
wherein if the vehicle is moving at the speed over the speed limitation, the inflator is capable of inflating the airbag when the condition of the vehicle achieves or exceeds the limitation, and if the first switch is turned off, the airbag is never inflated no matter the condition of the vehicle achieves or exceeds the limitation or not.

16. The wearable airbag system of claim 1, further comprising:
a first switch, wherein if the first switch is turned on, the inflator is capable of inflating the airbag when the condition of the vehicle achieves or exceeds the limitation, and if the first switch is turned off, the airbag is never inflated no matter the condition of the vehicle achieves or exceeds the limitation or not.

17. The wearable airbag system of claim 1, further comprising:
a second switch configured to make the inflator inflates the airbag no matter what condition of the vehicle if the second switch is turned on.

18. The wearable airbag system of claim 1, wherein the vehicle comprises at least a bicycle, a motorcycle, a car, a train, a boat or an airplane.

19. The wearable airbag system of claim 1, wherein the wearable airbag module is configured to be worn in clothes or out of the clothes.

20. The wearable airbag system of claim 1, wherein the measurement module is configured to be attached on the vehicle and thus move according to the vehicle.

21. A method for protecting a human on a vehicle with wearable airbag, the method comprising:
measuring a condition of the vehicle;
deciding if the condition achieves or exceeds a limitation or not; and
inflating an airbag of a wearable airbag module if the condition achieves or exceeds a limitation,
wherein the wearable airbag module comprises an airbag and an inflator configured to inflate the airbag.

22. The method of claim 21, wherein the condition of the vehicle comprises at least one of a tilt condition of the vehicle, a speed of the vehicle and an impact force acting on the vehicle,
wherein the measuring a condition of the vehicle comprises measuring if the tilt condition of the vehicle achieves or exceeds a tilt limitation, if variation of the speed of the vehicle in a predetermined time interval achieves or exceeds a speed variation limitation or if the intensity of impact force acting on the vehicle achieves or exceeds an intensity limitation, according to the measured condition of the vehicle, and
the inflating a wearable airbag module configured to be worn by the human if the condition achieves or exceeds the limitation comprising inflating the airbag of the wearable airbag module if the tilt condition of the vehicle achieves or exceeds a tilt limitation, if the variation of the speed of the vehicle in the predetermined time interval achieves or exceeds a speed variation limitation or if the intensity of the impact force acting on the vehicle achieves or exceeds the intensity limitation, accordingly,

23. The method of claim 21, wherein the vehicle comprises a first tire and a second tire, the measuring a condition of the vehicle comprising measuring first tire pressure of the first tire or measuring second tire pressure of the second tire,
wherein the inflating a wearable airbag module configured to be worn by the human if the condition achieves or exceeds the limitation comprising inflating the airbag of the wearable airbag module if the first tire pressure or the second tire pressure achieves or exceeds a first tire pressure limitation or a second tire pressure limitation, respectively.

24. The method of claim 21, further comprising
setting up or changing the limitation.

25. A method for protecting a human on a vehicle with wearable airbag, the method comprising:
deciding if the vehicle is moving at a speed over a speed limitation or not;
deciding if a transmitter disposed on the vehicle works regularly to be capable of transmitting a link signal or not;
deciding if a receiver coupled with a wearable airbag module works regularly to be capable of receiving the link signal or not,
wherein the wearable airbag module comprises an airbag and an inflator coupled with the airbag and capable of inflating the airbag;
deciding if the intensity of the link signal received by the receiver coupled with the wearable airbag module is smaller than or equal to an signal intensity limitation or not; and
controlling the inflator of the wearable airbag module to inflate the airbag of the wearable airbag module if the vehicle is moving at a speed over the speed limitation, the transmitter works regularly to be capable of transmitting the link signal, the receiver works regularly to be capable of receiving the link signal, and the intensity of the link signal is smaller than or equal to an signal intensity limitation.
